(19) United States
(12) Patent Application Publication
(10) Pub. No.: US 2009/0144066 A1
(43) Pub. Date: Jun. 4, 2009

(54) Method and System for Differential Billing

(75) Inventors: Andrew S. Van Luchene, Santa Fe, NM (US); Joel Mahoney, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, INC., Santa Fe, NM (US)

(21) Appl. No.: 11/948,036

(22) Filed: Nov. 30, 2007

(51) Int. Cl. G06Q 99/00; G06F 3/01

(52) U.S. Cl. 705/1; 715/760

(57) ABSTRACT

A system and method of distinguishing between transactions involving a widget and charging the same or different parties for the use, placement and content of the widget and clones of a widget based on those transactions. Such a system and method allows for differential billing for clones of widgets used on the same or different websites. Charges may be incurred based on the type of transaction and charges for the same or different transactions or the same or different uses of the same widget may be incurred by one or more customers.

### BACKGROUND

Online searches driven by Web-based search engines have proven to be one of the most prevalent uses of computer networks such as the Internet. Computer users can employ a variety of search tools to search for information as well as goods and services. Search results can appear in a variety of forms including virtual user interfaces such as a widget. Once users have identified the content of interest, they can frequently click on or otherwise select a link to learn more or make a purchase. However, it can be difficult to determine how to charge advertisers for such connections and which uses should be charged. It would therefore be advantageous to provide improved methods and apparatus for determining charges for widgets.

### BRIEF DESCRIPTION OF THE DRAWINGS

FIG. 1 is a block diagram depicting a network according to an embodiment of the present disclosure.

FIG. 2 is a block diagram depicting a system 100 according to one embodiment of the present invention.

FIG. 3 illustrates a method of activating a widget according to one embodiment of the invention.

FIG. 4 illustrates a method of cascading widgets according to an embodiment of the invention.

FIG. 5 illustrates a method of billing for transactions occurred using a widget according to one embodiment of the invention.

### DETAILED DESCRIPTION

Interactive distribution mediums such as the internet have created new ways for advertisers to reach consumers. Websites frequently have imbedded programs such as widgets or other portable pieces of code that can be installed and executed within any separate HTML-based web page by an end user without requiring additional compilation. Such programs may also be called gadget, badge, module, capsule, snippet, mini or flakes. Such widgets have myriad uses and can also be used for advertising purposes. A widget provides information on, or an interface to, a set of functionality or data. Widgets may be cloned so that the same widget appears on multiple different websites and may be used for the same or different purposes by multiple parties. The variety of uses and locations of clones of a widget makes it difficult to bill multiple parties for the use of all or part of a widget or widget clone.

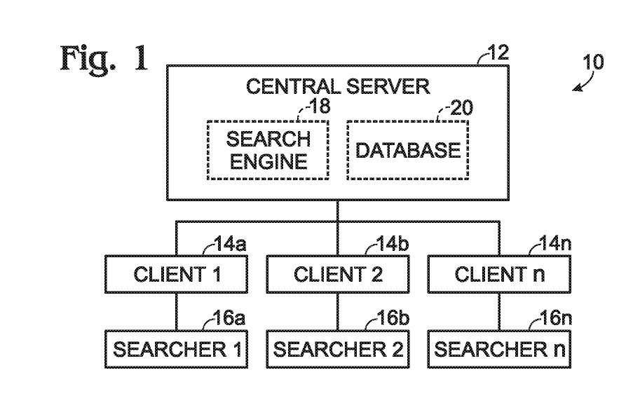

The herein described aspects and drawings illustrate components contained within, or connected with other components that permit improved online advertising. It is to be understood that such depicted designs are merely exemplary and that many other designs may be implemented to achieve the same functionality. Any arrangement of components to achieve the same functionality is effectively associated such that the desired functionality is achieved. FIG. 1 provides an exemplary network which may be used to support a virtual environment.

In FIG. 1, a system 10 suitable for use according to one embodiment of the present disclosure is depicted. As shown, the system includes a central server 12 which is in electronic communication with one or more client computing devices 14. Each client computing device 14 allows one or more users 16 to access central server 12. System 10 is configured such that a search engine can receive a search request from a user, retrieve search results from one or more databases, and provide the search results to the user. Numerous configurations for the locations of the search engine and databases are possible. According to the depicted embodiment, a search engine 18 and one or more databases 20 are hosted by central server 12. However, it will be readily understood that search engine 18 may, for example, be located on one or more client computing devices 14, on another server in electronic communication with central server 12, or elsewhere, so long as search engine 18 is in electronic communication with and accessible by the client computing device. Moreover, it will be further understood that databases 20 may be located, collectively or individually, in numerous locations in the system, including without limitation, on central server 12, on a different server, on a client computer device, etc. Moreover, it will be understood that search engine 18 may be capable of accessing a first database in a first location and a second database in a second location, etc. and assembling search results from multiple databases. Regardless of the location of the search engine and databases, the user will typically access the search engine through some type of user interface such as, for example, a web browser.

Central server 12 and client computing device 14 may be, for example, appropriately programmed general purpose or dedicated computers and computing devices. Accordingly, such devices will typically include a processor configured to receive and execute instructions from a computer program. Thus, it will be understood that the various processes and methods described herein may be implemented by an appropriately programmed general or purpose or dedicated computer or computing device.

For the purposes of the present disclosure, a “processor” means one or more microprocessors, central processing units (CPUs), computing devices, microcontrollers, digital signal processors, or like devices or any combination thereof. Typically a processor (e.g., one or more microprocessors, one or more microcontrollers, one or more digital signal processors) will receive instructions (e.g., from a memory or like device), and execute those instructions, thereby performing one or more processes defined by those instructions.

Thus a description of a process is likewise a description of an apparatus for performing the process. The apparatus can include, e.g., a processor and those input devices and output devices that are appropriate to perform the method.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

For the purposes of the present disclosure, the term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, CD-RW, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3 G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in aprocess does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having ordinary skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

User-friendly websites are increasing their use of widgets to simplify and enhance an internet user's experience, as they provide an easy mechanism for users to navigate sites and obtain relevant and/or desired information. Buttons, drop-down menus, as well as other elements located on a web page are widgets that may be manipulated by the user to perform a particular function. Such devices are useful for a variety of purposes including connecting consumers with particular advertisers, sources of information, and planning tools. Clones of widgets are instances of a widget that appear on a specific website. Each widget may be cloned and appear on one or more websites to be used by one or more parties. Widgets and clones of widgets may be assembled to form a web page or parts of a web page or used individually. A designer of a widget may wish for all or part of a widget or all or part of the content of a widget to be functional or to appear on particular websites or may wish to bill for part or all of the widget or content of the widget, or for particular uses of the widget or content displayed by the widget, or have different rates of use for different parts of the widget or different types of content displayed by the widget. Widgets may be created in-house or can be created by third parties such as JackRabbit Systems Inc., (Santa Fe, N. Mex.), which specializes in providing travel industry related widgets for tourism websites. An exemplary clone can be seen, for example, at www.santafe.org.

Various embodiments of the invention address this issue by providing a system configured to allow an administrator to configure portions of a widget or widget clone to be used with one or more billing systems. Such configurations allow portions or all of the widget to be assigned to any or multiple fee structures and provide a means for billable uses to be tracked and charged to the right entity regardless of where the clone is installed. Use of the widget or contents displayed by the widget or clone may be free, incur a flat fee per transaction or per clone, a variable fee, a flat rate, a commission, a variable rate, a subscription, a tiered price, any other pricing system or any combination thereof. In some embodiments, variable fee structures may have features that are escalating, deescalating, tiered, flat per usage, or commission based. Different pricing systems may be assigned to different parts or uses of the clone or the same uses of the clone by different entities. In some embodiments, charges may accrue only if particular events occur. For example, charges may accrue when transactions are completed, when transactions are initiated, when information is accessed, when a search is run, when a purchase is made, when an advertisement is shown, when information is printed, when information is copied, when information is forwarded, or by any other means of measuring the use of all or part of a widget or any combination thereof. In some embodiments, use of part or all of a widget or clone may incur different fees or different fee structures based on the time of day, the number of clicks or other selections, milestone numbers of clicks, monthly charges or other subscription arrangements, per event, per sale, per transaction, commission based, per advertisement shown, per advertisement clicked, the type of transaction, per information request, per information forwarded, per information printed, any other type of trackable transaction or any combination thereof. In some embodiments, the system can be configured to treat different events from the same widget as different billing events. For example, a request for additional information may be billed differently than a request to make a purchase, or a request to make a purchase may be billed differently than completion of a purchase. In other embodiments, the system can be configured to treat events from different clones as the same or different billing events. In additional embodiments, the location of a clone on a particular website may incur different fees or billing rates than the location of the same clone on a different website. For example, there may be websites that are more or less desirable or more or less successful and transactions that occur on those websites may incur different prices to a sponsor or vendor. In some embodiments, the system can be configured to divide charges among different parties. For example, charges for the use of a widget or the display of information in a widget may be incurred by the website, the provider of information in the widget, the owner of the item purchased through the widget, an event sponsor, any other third party or any combination thereof.

Those displaying information in a widget such as a particular advertiser may select in which widgets they wish to be included, on which websites they would like their information displayed, the amount of information displayed, whether inventory is displayed, whether purchasing is available through the widget, or any combination thereof. In some embodiments, an algorithm may track the amount of traffic particular widget clones receive on particular websites. Charges for appearing in or using a particular widget may depend in whole or in part on the amount of traffic a clone or website receives.

Widgets may be configured to accommodate the numerous billing relationships that exist in a single market place and bill accordingly. For example, a series of widgets may be designed which deal with the tourism industry. Such widgets may include booking engines, online guides, maps, directories, calendars, itinerary builders, reviews or any of a host of other widgets that may be useful in the tourism industry. The information provided by such widgets may be free for the consumer but incur charges for those listing or promoting particular events or venues. In other embodiments, charges may be incurred by the consumer alone or in conjunction to charges incurred by those listing or promoting particular events or venues. In some embodiments, charges may be incurred by the primary advertiser or clone even though the widget is not on the sponsor's website. For example, widgets carrying information about a specific event may be displayed on numerous websites, but charges may accrue to the event sponsor regardless of the location of the widget. In other embodiments, websites may be constructed for promotion purposes and the website may be responsible for charges. For example, a board of tourism may construct a website with widgets regarding events, accommodations, restaurants, points of interest, or other items they wish to promote and even though they are not the primary holder of the event, accommodation, restaurant or other item, they may pay a fee for using or displaying the widget or information within the widget.

It will be appreciated that there can be a nearly infinite number of revenue sharing arrangements and that the billing mechanism for the widgets described herein may be customized to accommodate any type of revenue sharing or distribution plan. Furthermore, the particular revenue sharing/billing mechanism for a particular widget on a particular website may include myriad plans. For example, the paying party and the party receiving payment for a particular widget on a particular website at any given time may change based on any number of factors including the past or future behavior of the user who clicks on the widget—e.g. websites/or widgets the user has previously visited, websites/widgets the user visits after using the current widget, whether the user makes a purchase, the number of users who visit, the number of users who visit from a particular website, time of day, etc.

For example, a system may be configured to promote a particular region or city and events in that city. Widgets of interest may include booking engines which link reservation systems with end user searches; customized online guides which send custom event listings based on the information provided; directories which post categories of the total system to web pages on a clone site; calendars which display events that are listed according to date; maps that display events and the locations of such events; banner advertisements; itinerary builders that pull information from other widgets and create a personal itinerary for an end user; reviews allowing end users to post comments visible to other users; and automated email systems that sent emails to end users based on their preferences and previous events of interest to name a few. Each clone of a widget may generate separate billing profiles, or may track viewers, users who select the widget, transactions incurred through the widget, information sent out as a result of the use of the clone, the number of times a clone is displayed, the number of times a clone is selected, the number of times information is copied, moved, forwarded, printed or any combination thereof. Such widgets may be cloned and placed on one or more websites such as state run websites, local chamber of commerce websites, local newspaper websites, local convention and visitor's bureau websites, local magazine websites, various travel related websites, as part of search engines and in particular browsers. In some embodiments, different websites may incur different charges for the same widgets or clones of widgets.

For example, a local chamber of commerce may desire to promote a particular city or region. A website for the chamber of commerce may include a widget for a calendar displaying upcoming events. Each time an event is selected, a charge may be incurred to the event promoter, or to the chamber of commerce, or to another third party, or a combination thereof depending on the type of billing arrangement. Events selected may prompt the production of maps displaying the location of events or a booking information listing hotels, nearby restaurants, shopping venues, tourist attractions, additional events occurring around the same time, art galleries, or any other type of information related to or of potential interest for someone viewing an event. Booking engines may be available in the same or companion widgets to secure reservations for accommodations or restaurants, or tickets for events. Charges may be incurred when bookings are made, when the related advertisements are generated or selected, when the booking engine is run regardless if an actual reservation is made or any combination thereof. For example, a charge may be incurred each time a search is run through a booking engine in a widget or clone of a widget. A subsequent charge may be occurred if a reservation is made. Banner advertisements may also be run containing related advertisements, or advertisements based on the keywords or behavior of the end user. A widget may also be used to create a personalized itinerary based on the information selected or chosen by the end user. Such an itinerary may include particular events and other reservations. Charges may be incurred by the vendors when items are added to the itinerary, when the itinerary is accessed, printed or forwarded, or any combination thereof.

In another embodiment, a directory may post categories of total systems such as accommodations or restaurants to web pages on a website. When information is entered through a booking engine, events that match the time period entered may be displayed. In some embodiments, the listing of events may rotate based on information received, prices paid, a predetermined schedule, randomly, or any combination thereof. For example, tiered pricing may be used in which those who pay premium prices appear higher on a list, but among those who have paid the same price, the order may be based on a rotation.

In a further embodiment, a custom online guide may be created. For example, end users may fill out a form and receive custom event listings based on their areas of interest. Along with the event listings, additional information of nearby sites of interest and tourist attractions, accommodations and restaurants may be displayed. The online guide may also include booking engines that list the availability of particular accommodations or restaurants on dates around the event of interest. Billing systems may be used to charge for listing each of the events, listing the accommodations or restaurants, every time reservations or made, listing of the points of interest, or any combination thereof.

In some embodiments each widget may function independently. In another embodiment, multiple widgets may work in concert in that interaction with one widget may trigger the generation of information from another complementary or companion widget. Such interactions may occur on one or more webpages on one or more websites. For example, there may be a series of related widgets such as an events calendar, a booking engine, an interactive map, a travel guide, a directory, and an itinerary builder. Selection of an event may trigger activation of a booking engine widget in which nearby accommodations, restaurants, or other services may appear. A reservation through the booking engine may trigger the building of an itinerary on an itinerary building widget. The creation of an itinerary may activate a map showing the location of all of the events on the itinerary. In another embodiment, the selection of a location on an interactive map may trigger a listing of accommodations, restaurants or services near the location on the map. In a further embodiment, a reservation through a booking engine widget may prompt the display of events occurring at the time of the reservation. Interaction with any one related widget may trigger an action by one or more other related widgets.

In some embodiments, widgets may be configured to display different information on different websites. For example, there may be specials run on a particular website which effect the information or pricing run in a particular clone or which are only available when a clone is used through that website.

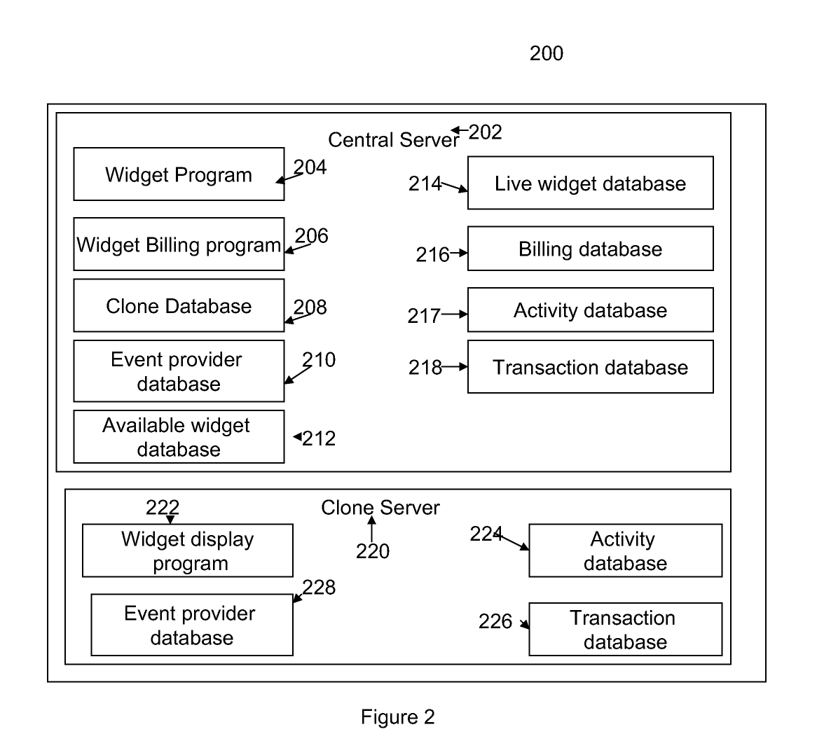

An exemplary system 200 configured to provide a billing system as described above is shown in FIG. 2. As shown, system 200 may include a central server 202 and one or more clone servers 220. In some embodiments, all information may be stored on a single central server.

Central server 202 may include programs such as a widget program 204 and a widget billing program 206, as well as various databases such as a clone database 208, event provider database 210, available widget database 212, live widget database 214, billing database 216, activity database 217, transaction database 218 or any other programs are databases useful in maintaining and displaying widgets.

Widget program 204 may be responsible for a variety of functions such as, but not limited to, maintaining and operating widgets.

Clone database 208 may include information such as clone ID, clone descriptors, clone types, clone attributes, billing rules, widgets, rules and any additional information necessary to manage clients and widgets on clone sites.

Event provider database 210 may include information such as event ID, event information, event website, event billing rules, widgets, rules and any additional information regarding the event that would be useful in promoting the event.

Available widget database 212 may include information such as widget id, widget type, widget descriptor, widget attributes, or any additional information about the widget.

Live widget database 214 may include information about widgets that are running on clone sites including widget ids, widget types, widget descriptors, widget attributes, event identifications, clone identifications and rules, or any other information regarding widgets that are in use.

Billing database 216 may include information such as event provider identification, event provider billing rules, event billing provide billing amounts, clone identification, clone provider rules, clone identification provider billing amounts, or any other information necessary for accurately tracking and billing for widget use.

Activity database 217 may include clone identification, event identification, widget identification, click type identification, and date of activity or any additional information useful in tracking activity involving a particular widget.

Transaction database 218 may include clone identification, event identification, widget identification, click type identification, date of activity, and if the transaction was completed, or any additional information useful in tracking transactions.

Clone server 220 may include a widget display program 222, an event provider database 228, an activity database 224 and a transaction database 226.

Event provider database 228 may include information regarding the events to be featured or displayed in the clone widget including information such as event ID, event information, event website, event billing rules, special rates, rules and any additional information regarding the event that would be useful in promoting the event. In some embodiments, particular clones or websites displaying a clone may have promotions or other special events, rates, coupons, or other promotional materials that are specific to that clone or website. Information regarding such promotions may be stored along with the details of the event in the event provider database.

Activity database 224 may include clone identification, event identification, widget identification, click type identification, type of transactions, number of viewers and date of activity or any additional information useful in tracking activity involving a particular widget on a particular website.

Transaction database 226 may include clone identification, event identification, click type identification, date of activity, type of transaction, completion of transaction, amount of transaction, reservation identification, billing information, receipt of information, or any additional information useful in tracking transactions of a clone on a particular website.

A widget may be incorporated into a website in a variety of ways. In some embodiments, a widget owner may receive a request to create a clone of widget. Once a request has been received, the parameters of the widget may be configured by the widget provider, the widget host, or by advertisers listed in the widget, who may be able to define parameters for their specific listing in order to match the needs of the requester. For example, a website may want to include certain types of information or particular advertisers in a widget. In some embodiments, advertisers may indicate in which types of widgets or on which types of websites they are willing to appear. Advertisers may select classes of websites or classes of advertisers, or prices of advertisements they are willing to pay. In other embodiments, advertisers may have a minimum amount of traffic or particular click through rate which they are interested in receiving. The widget owner may determine the amount of traffic or the click through rates of particular widgets and include the advertisers in the widgets that meet a particular advertiser's requirements. In some embodiments, advertisers may register with the widget owner and may be contacted if a request for a widget matching their target criteria is requested. In other embodiments, requesters of widgets may have particular advertisers they wish to include in the widget. In further embodiments the widget owner may contact advertisers of interest. In additional embodiments, once a widget is running, an advertiser may contact the widget owner or the website displaying the widget and indicate that they would like to be included in the widget. In some embodiments, the widget may scrape data from an inventory system of the advertiser. Advertisers may indicate how much or how little data they are willing to have scraped by the widget. In other embodiments, the widget may connect an end user with a purchasing/inventory system of the advertiser. The widget owner may additionally configure the billing type and any billing rules and conditions that apply to the use of the widget prior to activating the widget clone in the website.

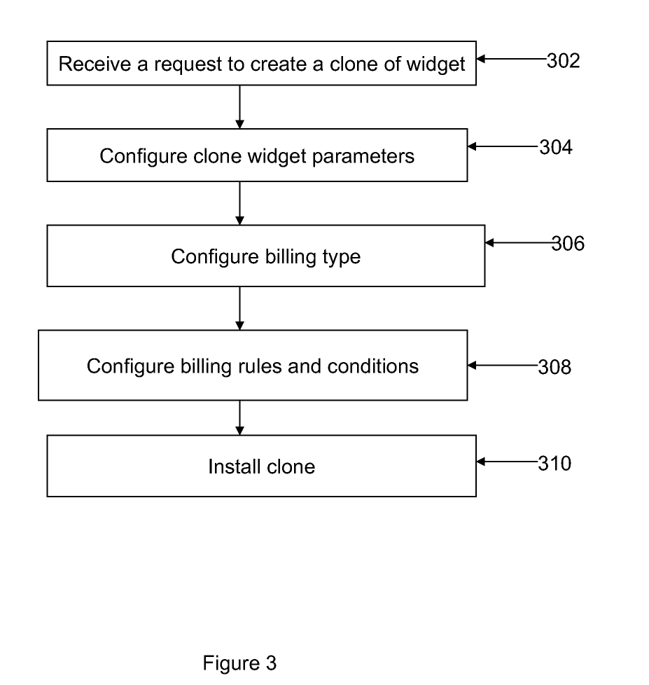

In some embodiments, a widget may be constructed using some or all of the steps in FIG. 3. For example, a widget owner may receive a request to create a clone of a widget in 302. The widget owner may configure the clone widget parameters in 304 to meet the needs of a particular website. Parameters may include specific functionality, particular advertisers, particular interactions, the type of information conveyed, the formatting of the information conveyed, the connectivity of the information conveyed, hyperlinks, data transfers, data scrapes, or any other functionality parameters that may be useful in a widget. The billing type is configured in 306. The billing type may include fee schedules, pricing systems to be implemented, as well as the division of billing if multiple parties incur charges. Particular billing rules and conditions, i.e. the types of transactions that incur charges, the conditions required for a charge to be incurred, and how the charge is calculated are established in 308. The clone is then installed in 310.

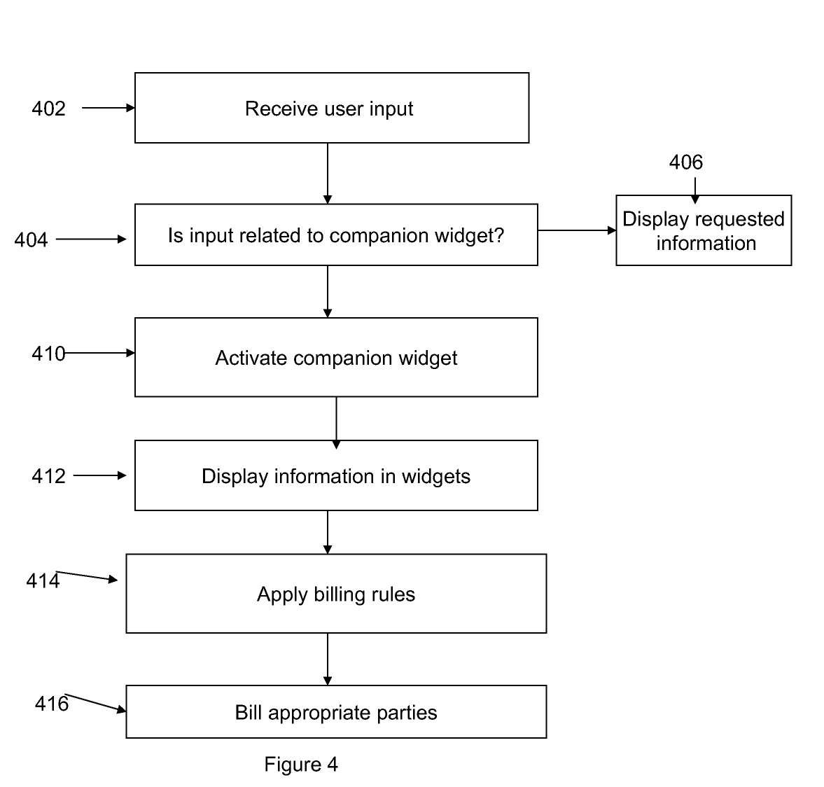

In some embodiments, clones of the same or different widgets may be interrelated. Such clones may be located on the same or different web pages and/or websites. Information inputted into or activation of one clone may trigger the display of information or a transaction on another clone of the same or a different widget. For example, as shown in FIG. 4, a consumer or other end user inputs information into, selects, or otherwise activates a clone at 402. A determination is made at 404 as to whether the input is related to a companion widget. If the input is related to a companion widget, the companion widget is activated at 410. If it is not related to a companion widget, the requested information is displayed at 406 and no other widget is activated. If a companion widget is activated, information is displayed on the related widgets at 412. For example, if an event is selected from a calendar, the event may be added to an itinerary in an itinerary building widget; a booking engine widget may run a search for accommodations or restaurants that have an availability around the date of the event; an interactive map may display the location of the event and nearby accommodations, restaurants, and/or points of interest; any other related widget, or any combination thereof may be activated. Billing rules for the use of the clones are applied at 413 and the appropriate parties are billed at 416.

Billing may be calculated by any means feasible. In some embodiments, billing may be determined on a monthly basis, a quarterly basis, a weekly basis, an annual basis, or any other time period. The billing type may be flat fee, a commission, variable pricing, tiered pricing, subscription, a variable fee, a variable rate, a fixed rate, or a combination thereof. In some embodiments, billing may be divided among more than one party. In other embodiments, charges may be accrued due to a particular billing rules or conditions such as the occurrence of particular events. For example, charges to the sponsor, advertiser, website owner or other third party may be determined by a click on a widget, the mailing of information, a request for information, the entering in of specific data, a search using the widget, the completion of a transaction, the number of times an advertisement is viewed, the number of times an advertisement is shown, commissions on a transaction, the use of information, printing of information, forwarding of information, any other measurable means or a combination thereof. In some embodiments, widgets may be interrelated. Billing charges may be incurred for each transaction in each widget or clone, each transaction specific to a particular widget or clone, on a prorated basis between related widgets or clones, for each unique user or user session or any combination thereof.

In some embodiments, every billing cycle, some or all of the following steps may be used, for example by widget billing program 206:
1. Retrieve use and performance of a clone.
2. Retrieve billing type, rules and conditions.
3. Generate invoice based on performance, use, billing type, and rules and conditions.
4. Output invoice.
5. Generate Accounts Payable report based on performance, use, billing type, and rules and conditions.
6. Output accounts payable report or generate automated payments.
   (lets also be sure to cover revenue sharing. Sometimes we pay a clone and sometimes the clone pays us

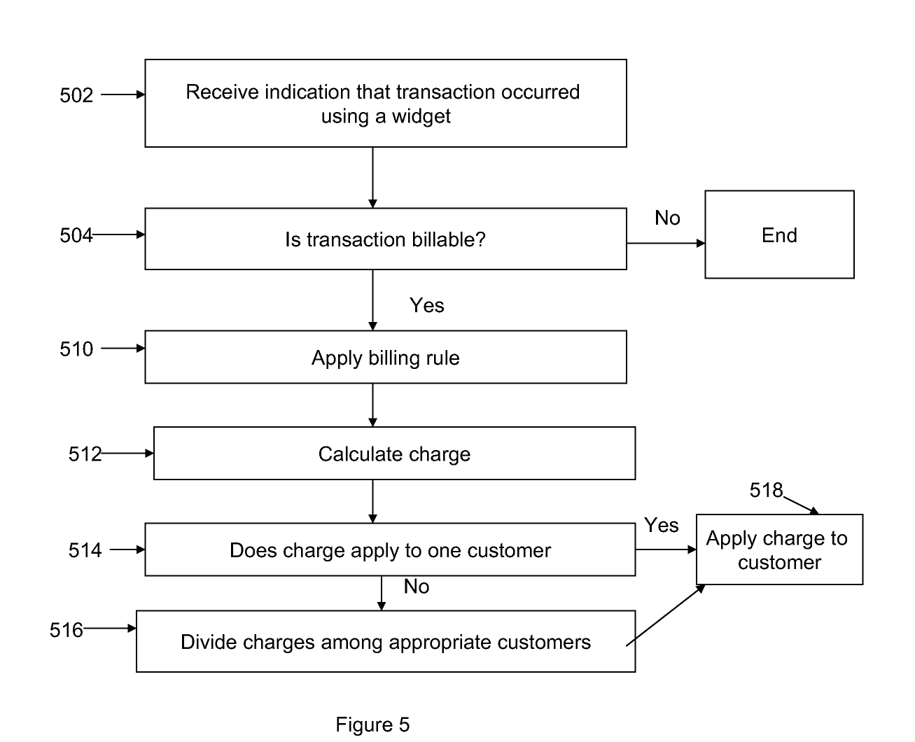

In other embodiments, billing may be calculated using some or all of the steps in FIG. 5. In FIG. 5, an indication is received that a transaction has occurred at 502. Once the transaction has occurred, a determination is made at 504 as to whether the transaction was a billable or non-billable use of the widget. If it was a non-billable use of the widget, no further steps are taken. If it is a billable use of the widget, a billing rule is applied in 510. Such a billing rule may determine how fees are assessed for the transaction. The billing rule may depend on the type of transaction, the location of the clone, the number of similar transactions that have previously occurred, or any combination thereof. Fees may be assessed by any means applicable including, but not limited to, per transaction, type of transaction, commission based, flat fee, flat rate, variable rate, variable fee, subscription rates, or any combination thereof. The charge for the use of the widget may then be calculated in 512. A determination is made as to who should be charged at 514. In some embodiments, charges are billed to particular customers, for example an advertiser or event promoter. In other embodiments, charges may be apportioned among more than one customer according to a predetermined schedule. For example, a board of tourism may sponsor a clone of a widget on a website promoting a particular region. A vendor such as a hotel may have booking information or a reservation engine in the widget. If a hotel reservation is made, charges may be incurred by either or both the hotel and the board of tourism or another third party. If only a single customer is to receive charges, charges are applied in 518. If charges are to be divided among more than one customer, they are divided in 516 and then applied to the appropriate customer in 518.

Similar arrangements may be used for non-billing purposes. For example, in some embodiments, it may be useful to track how many users view or select a particular widget; the type of information they request; how they enter information; sources of interest; search terms; how many transactions are completed; the value of particular transactions; the construction of itineraries; the value of the itineraries; how many transactions are not completed; what information is copied, printed or forwarded; if a particular user runs multiple searches; the amount of repeat usage that occurs; how the widget is accessed, for example through a computer, mobile phone or video game console; or any other data that may be useful in more efficiently targeting the information displayed. Widgets may be configured to capture such information in conjunction with or apart from tracking charges for billing.

### CONCLUSION

It will be appreciated that the configurations and routines disclosed herein are exemplary in nature, and that these specific embodiments are not to be considered in a limiting sense, because numerous variations are possible. The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

We claim:

1. A method of billing for the use of a widget comprising:
creating multiple clones of a widget; and
configuring the clones of the widget to bill for the use of the widget wherein at least two different parties are billed for use of the same widget.

2. The method of claim 1, wherein multiple clones of the widget may be created.

3. The method of claim 2, wherein the clones of the widget may be located on more than one webpage.

4. The method of claim 2, wherein the use of each clone of the widget may incur different charges.

5. The method of claim 1, wherein the use of the clone of the widget may be determined by a transaction.

6. The method of claim 5, wherein the transaction may be a click on the clone of the widget.

7. The method of claim 5, wherein the transaction may be a purchase through the clone of the widget.

8. The method of claim 5, wherein the transaction may be connection to a booking engine.

9. The method of claim 5, wherein different transactions on the same clone may incur different charges to different parties.

10. The method of claim 5, wherein the same transactions on different webpages may incur different charges.

11. The method of claim 1, wherein each clone may bill more than one party.

12. The method of claim 11, wherein each clone may bill more than one party for a single transaction.

13. The method of claim 11, wherein each party may have a different billing arrangement.

14. A system of promotion comprising:
a web page containing one or more widgets;
a user interface configured to allow a user to interact with the widget wherein interaction of the user with a widget generates a change in a second widget.

15. The system of claim 14, wherein the second widget is complementary to the first widget.

16. The system of claim 14, wherein the second widget is located on a different web page than the first widget.

17. The system of claim 14, wherein the second widget is located on a different web site than the first widget.

18. The system of claim 14, wherein the second widget is located on the same web page as the first widget.

19. The system of claim 14, wherein the user interface is configured to allow a user to interact with the second widget.

20. The system of claim 19, wherein interaction with the second widget generates a change in the first widget.
